(19) United States
(12) Patent Application Publication
(10) Pub. No.: US 2005/0095330 A1
(43) Pub. Date: May 5, 2005

(54) Method for collecting and packaging of fresh produce

(76) Inventor: John Anthony Guido, Los Banos, CA (US)

Correspondence Address: LAW OFFICE OF PHILIP A STEINER, 846 HIGUERA STREET, SUITE 11, SAN LUIS OBISPO, CA, 93401, US

(21) Appl. No.: 10/699,187

(22) Filed: Nov. 1, 2003

(51) Int. Cl. A23C 3/00

(52) U.S. Cl. 426/324

(57) ABSTRACT

A method for consolidating canning, pulp, paste, or shelf stable processing and fresh cut produce processing which utilizes existing harvesting and processing facilities. The method comprises the steps of machine harvesting a plurality of fresh produce for example tomatoes, placing the plurality of fresh produce into a cut, pulp or paste processing stream associated with a shelf stable processing system, diverting superior quality produce into a fresh cut produce stream, cutting the diverted portion of the fresh produce and depositing the fresh cut produce into one or more packages. In one embodiment of the invention, the one or more packages comprise modified atmosphere packages. In another embodiment of the invention, at least the tops and bottoms are removed from the diverted fresh produce. The removed tops and bottoms and any juices generated by the cutting are then reintroduced into the shelf stable processing stream thus improving production yield and reducing unnecessary solid waste generation.

### FIELD OF INVENTION

The present invention relates generally to a fresh produce processing method and more specifically to a method of processing fresh produce which consolidates fresh produce pulp, fresh sliced produce or fresh produce paste and fresh cut produce processing methods.

### BACKGROUND

Demand for fresh cut produce such as fresh cut fruits and vegetables is increasing significantly as consumers become more health conscious and the nutritional benefits of consuming fresh fruits and vegetables becomes more well known and understood.

In the relevant art, fresh produce intended for the fresh cut produce market is harvested and processed separately from high volume shelf stable processing. The term “shelf stable processing” includes both aseptic bagging and canning processing streams.

Typically, fresh produce intended for the fresh cut produce market is harvested by hand from the field, transported to a central facility unrelated to shelf stable processing, cleaned and aesthetically undesirable or unpalatable sections such as the produce tops or ends are removed and simply thrown away.

Needless to say, current fresh cut produce processing is inefficient, labor intensive and wasteful of otherwise useful fresh produce products and juices which could be added to the shelf stable processing stream to improve production yields. Furthermore, the waste generated from the removed undesirable sections adds to the volume of solid waste generated by a facility and is often disposed of in a sanitary landfill. The unnecessary waste disposal reduces the available capacity of the landfill and impacts the environment by adding to the total volume of disposed solid wastes.

Therefore, it is highly desirable to consolidate fresh cut produce processing and shelf stable processing of produce in a way which utilizes existing harvesting and shelf stable processing systems, increases the shelf stable production yield, reduces solid waste generation and reduces labor costs associated with separate field harvesting and processing methods for fresh cut produce markets.

### SUMMARY

This invention addresses the limitations discussed above and provides a method for collecting and packaging of fresh produce using existing shelf stable produce harvesting and processing methods, decreases the volume of solid waste generated and increases shelf stable processing production yields. In addition, the inclusion of modified atmosphere packaging provides greater shelf-life for the fresh cut product which simplifies the distribution of the fresh cut produce products and lowers the overall product loss rates.

The term fresh produce comprises a wide variety of fruits and vegetables including tomatoes, bell peppers, apples, oranges, pears, peaches, apricots, beets, strawberries, plums, nectarines, melons, papayas, onions, guavas, etc.

The invention comprises the steps of machine harvesting a plurality of fresh produce, for example tomatoes, placing the plurality of fresh produce into a shelf stable processing stream, diverting a portion of the fresh produce from the shelf stable processing stream into a fresh cut produce processing stream, cutting the diverted fresh produce and depositing the fresh cut produce into one or more packages. In one embodiment of the invention, the one or more packages comprise modified atmosphere packages. In a further embodiment of the invention, the modified atmosphere packages incorporate at least a transparent lid or a transparent bag.

In an alternate embodiment of the invention, additional steps are performed which comprises removing one or more undesirable sections and/or defective produce from the diverted select fresh produce and reintroducing at least a portion of the removed undesirable sections into the shelf stable processing stream. The one or more undesirable portions comprise the tops, ends or juices removed from the diverted fresh produce.

The diversion of fresh produce is performed by observation of one or more visual characteristics associated with the fresh produce. The one or more visual characteristics include color, ripeness, size, damage or defects (or lack thereof), juiciness and aesthetic appeal.

### BRIEF DESCRIPTION OF DRAWINGS

FIG. 1—This drawing depicts at least the major steps for implementing the invention.

### DETAILED DESCRIPTION

This invention comprises a method for consolidating fresh cut produce processing and shelf stable produce processing. The invention provides for the diversion of superior quality produce from a normal shelf stable process stream to a fresh cut produce processing stream. The diverted produce is sorted by humans and/or machines for defects such as bruises, damages, infestations, decay, improper coloration, inadequate size, improper ripeness or other undesirable aesthetic qualities. Those items of fresh produce which are retained may be further processed to remove at least the tops and bottoms from the retained produce. In addition, partially defective sections may be removed as well. Substantially all of the usable rejected produce, produce juices and the cut tops and bottoms are returned to the shelf stable processing stream which eliminates much of the solid waste and yield loss generated by conventional fresh cut produce processing methods.

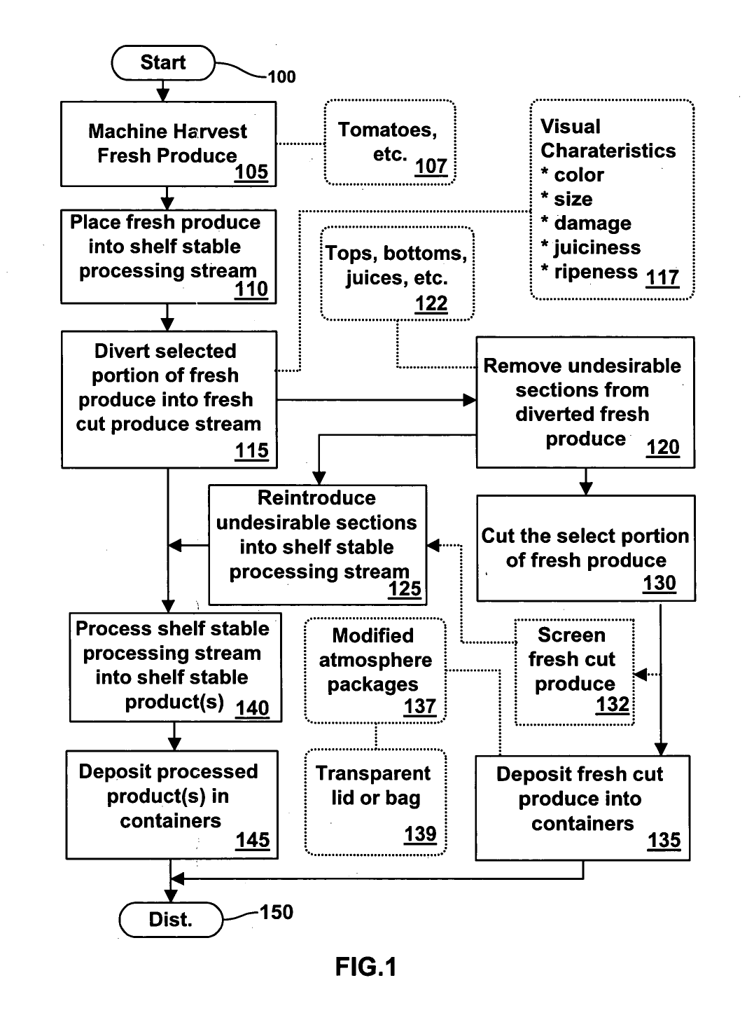

Referring to FIG. 1, the steps to practice the invention are described. The process begins 100 by machine harvesting of fresh produce 105. The fresh produce comprises fruits or vegetables such as onions, bell peppers, tomatoes 107, apples, oranges, etc. The fresh produce is harvested using mechanical harvesters and transported by gondolas or other means to a centralized shelf stable processing facility.

The fresh produce is offloaded from the transportation means and placed into a shelf stable process stream 110. An example of a highly automated agricultural production system is disclosed in U.S. patent RE 31,023 to Hall.

The input of fresh produce into the shelf stable process stream is observed for visual characteristics representative of superior grade or otherwise aesthetically appealing produce. Examples of relevant visual characteristics include color, ripeness, size, tenderness, damage or defects (lack thereof), juiciness and/or other visually aesthetic features which may affect the freshness or salability of the fresh cut produce product 117.

Those items of fresh produce which meet the visual characteristic criteria are diverted into a fresh cut produce processing stream 115. The diverted fresh produce is then cut 130 and deposited into packages 135 for distribution 150. In one embodiment of the invention, the fresh cut produce is packaged in modified atmosphere packages (MAP). Additional observations may be performed on the diverted fresh produce to further screen out 132 undesirable fresh produce. Those items of fresh produce which are screened out of the fresh cut produce process stream are generally returned to the shelf stable processing stream.

Suitable packaging materials for use in this invention are commercially available from numerous suppliers. For example, Cryovac Division of W.R. Grace & Company, Duncan, S.C. www.crvovac.com (See PD 900 family of films.) Other modified atmospheric packaging systems are available for a variety of vendors known in the relevant art.

In another embodiment of the invention, undesirable sections are removed from the diverted fresh produce 120. The undesirable sections include such features as juices stem tops, ends, bruised portions, damaged portions, decayed portions, insect infested portions, non-uniform colorations, etc. 122.

The useable removed sections (bruised, damaged, tops, ends, or non-uniform colorations) and otherwise unsuitable produce are then reintroduced into the shelf stable processing stream 125 and processed along with the remaining undiverted shelf stable processing stream 140. The final shelf stable product is then deposited in containers 145 for distribution 150. This rerouting of otherwise useable fresh produce products reduces unnecessary product waste and increases shelf stable product production efficiency.

It will be appreciated by one skilled in the art that the term fresh produce applies to a broad range of fruits and vegetables which may be processed in a shelf stable processing stream in which a portion of may be diverted and processed as fresh cut produce in accordance with the invention disclosed herein.

The foregoing described embodiments of the invention are provided as illustrations and descriptions. They are not intended to limit the invention to precise form described. In particular, it is contemplated that changes to the invention described herein may be implemented equivalently using different processing facilities and/or fresh produce products than described herein. Other variations and embodiments are possible in light of above teachings, and it is not intended that this Detailed Description limit the scope of invention.

1. A method for collecting and packaging of fresh cut produce comprising:
machine harvesting a plurality of fresh produce,
placing said plurality of fresh produce into a shelf stable processing stream,
diverting a select portion of said plurality of fresh produce from said shelf stable processing stream,
cutting said diverted select portion of said fresh produce and
depositing said cut diverted select portion of said fresh produce into one or more containers.

2. The method according to claim 1 wherein said diverting further comprises;
removing one or more undesirable sections from said diverted select portion of said fresh produce, and
reintroducing at least some of said removed one or more undesirable sections or at least a portion of any juices generated by said removing of one or more undesirable sections into said shelf stable processing stream.

3. The method according to claim 1 wherein said plurality of fresh produce comprises tomatoes, bell peppers, apples, oranges, pears, peaches, apricots, beets, strawberries, plums, nectarines, melons, papayas, onions or guavas.

4. The method according to claim 1 wherein determination of which of said plurality of fresh produce is diverted is based at least in part on one or more visual characteristics.

5. The method according to claim 4 wherein said one or more visual characteristics includes color, ripeness, size, damage, defects, tenderness, juiciness or aesthetic appeal.

6. The method according to claim 2 wherein said one or more undesirable sections includes a top, an end, or juices removed from at least one member of said select portion of said plurality of fresh produce.

7. The method according to claim 1 wherein said one or more containers includes one or more modified atmosphere packages.

8. A method for collecting and packaging of fresh cut produce comprising the steps of:
machine harvesting a plurality of fresh produce,
placing said plurality of fresh produce into a shelf stable processing stream,
diverting a select portion of said plurality of fresh produce based at least in part on one or more visual characteristics,
removing one or more undesirable sections from said diverted select portion of said fresh cut produce,
reintroducing at least said removed undesirable sections into shelf stable processing stream,
cutting said diverted select portion of said fresh produce, and
depositing said diverted select portion of said fresh cut produce into one or more containers.

9. The method according to claim 8 wherein said plurality of fresh produce comprises tomatoes.

10. The method according to claim 8 wherein said one or more visual characteristics includes color, ripeness, size, damage, tenderness, defects, juiciness or aesthetic appeal.

11. The method according to claim 8 wherein said one or more undesirable sections includes at least a plurality of tops, ends or juices removed from said diverted select portion of said fresh produce.

12. The method according to claim 8 wherein said one or more packages includes one or more modified atmosphere packages.

13. The method according to claim 12 wherein said one or more modified atmosphere containers includes a transparent lid or a transparent bag.

14. A method for collecting and packaging of fresh cut tomatoes comprising:
machine harvesting a plurality of fresh tomatoes,
placing said plurality of fresh tomatoes into a shelf stable processing stream,
diverting a select portion of said plurality of fresh tomatoes,
cutting said diverted select portion of said fresh tomatoes, and
depositing said cut diverted select portion of said fresh tomatoes into one or more modified atmosphere packages.

15. The method according to claim 14 wherein said diverting further comprises;
removing one or more undesirable sections from said diverted select portion of said fresh tomatoes, and
reintroducing at least said removed undesirable sections into said shelf stable processing stream.

16. The method according to claim 15 wherein said one or more undesirable sections comprises a plurality of tops, ends or juices removed from said diverted select portion of said fresh tomatoes.

17. The method according to claim 14 wherein said one or more modified atmosphere packages incorporates a transparent lid or a transparent bag.

18. The method according to claim 14 wherein said diverted select portion of said fresh tomatoes is diverted based at least in part on one or more visual characteristics of said plurality of fresh tomatoes.

19. The method according to claim 18 wherein said one or more visually observable characteristics includes color, ripeness, tenderness, size, damage, defects, juiciness or aesthetic appeal.
